(19) United States
(12) Patent Application Publication
(10) Pub. No.: US 2006/0209353 A1
(43) Pub. Date: Sep. 21, 2006

(54) Image processing system, image processing device and image processing method

(76) Inventors: Kohsuke Harada, Nara (JP); Tokiyuki Okano, Yamatokoriyarna (JP); Keiji Nakamura, Nara (JP); Takashi Nishimachi, Nara (JP); Shuhji Fujii, Kyoto (JP); Yasuhiro Nakai, Kyoto (JP)

Correspondence Address: BIRCH STEWART KOLASCH & BIRCH, PO BOX 747, FALLS CHURCH, VA, 22040-0747, US

(21) Appl. No.: 10/552,997

(22) PCT Filed: Apr. 8, 2004
(86) PCT No.: PCT/JP04/05100

§ 371 Date: Oct. 13, 2005

(30) Foreign Application Priority Data
Apr. 14, 2003 (JP) 2003-109555

(51) Int. Cl. H04N 1/00

(52) U.S. Cl. 358/403; 358/448

(57) ABSTRACT

In an image processing apparatus connected with a computer which is capable of executing image processing which corresponds to an image processing command, a file format which permits addition of the image processing command to image data which has been read is stored in a non-volatile memory. A CPU judges whether a determined file format is stored in the non-volatile memory, and when judging that the determined file format is stored in the non-volatile memory, the CPU permits addition of the image processing command to the read image data.

This application is a continuation of PCT International Application No.PCT/JP2004/005100 which has an International filing date of Apr. 8, 2004, which designated the United States of America.

### TECHNICAL FIELD

The present invention relates to an image processing apparatus such as an MFP which sends image data read using an image scanner or the like to an image receiving apparatus such as a computer, an image processing system comprising such an image processing apparatus, and an image processing method.

### BACKGROUND ART

Where image data read with an image processing apparatus such as an MFP which comprises an image reading device such as an image scanner are to be sent to an information processing apparatus (image receiving apparatus) such as a computer so that the information processing apparatus will be able to use the image data, depending upon a combination of the original of vertical writing or horizontal writing and the direction in which the original to be read is placed, it is necessary to rotate the read image data in order to correctly display the image data. A method available to this end requires that the image processing apparatus sends thus read image data to the computer and in response to a user operation, the computer rotates the image data (hereinafter referred to as the “user processing-based method”). Other method available requires that the image processing apparatus rotates the image data and sends the rotated image data to the computer (hereinafter referred to as the “image processing apparatus-based method”).

Yet another method available requires that a command (image processing command) instructing rotation is added to the image data read with the image processing apparatus and is then sent to a computer which is capable of processing the command, the computer executes rotation processing which is demanded by the command, and the rotation processing is performed without a user operation (hereinafter referred to as the “command-based method”). (See Japanese Patent Application Laid-Open No. 2-257286 (1990) for example.)

The user processing-based method has a problem that although a load upon the image processing apparatus is minimum, a load upon a user is heavy and the convenience to the user is poor. Meanwhile, the image processing apparatus-based method has a problem that although a load upon a user is minimum, a load upon the image processing apparatus is heavy, which manifests itself as an adverse influence such as a slowed down processing speed of the image processing apparatus.

The command-based method mentioned above, although imposing only a light load upon the image processing apparatus and requiring no user operation, causes a problem that all computers which receive image data from the image processing apparatus are not necessarily equipped with an application which is capable of processing commands requiring rotation and the like so that when a computer can't process the commands, the image data must be rotated in response to a user operation. There is a further problem that since the commands requiring rotation and the like are not necessarily compatible with all file formats, when image data is to be sent in a file format not compatible with the command, the command-based method mentioned above can not be used.

### DISCLOSURE OF THE INVENTION

The present invention has been made in light of this and accordingly aims at providing an image processing system, an image processing apparatus and an image processing method which permit addition of an image processing command in accordance with a file format into which read image data will be converted, to thereby effectively disperse a processing load and improve the convenience to users.

Other object of the present invention is to provide an image processing apparatus and an image processing method which prohibits addition of the image processing command in accordance with a file format into which read image data will be converted, to thereby effectively disperse a processing load and improve the convenience to users.

Still other object of the present invention is to provide an image processing apparatus which determines whether to use the image processing command in accordance with a load condition, to thereby effectively disperse a processing load and improve the convenience to users.

An image processing system according to the present invention comprises an image processing apparatus, which comprises adding means for adding an image processing command to image data, reads image data of an original and converts thus read image data into a file format which is determined from among plural file formats, and an image receiving apparatus which receives from the image processing apparatus the image data converted into the file format thus determined, and when the image processing command is added to the image data thus received, performs upon thus received image data an image processing which corresponds to the image processing command thus added, wherein the image processing apparatus comprises: a storage unit which stores a file format which permits addition of the image processing command to the read image data; and judging means for judging whether the file format thus determined is stored in the storage unit, and when the judging means judges that the file format thus determined is stored in the storage unit, addition by the adding means of the image processing command to the read image data is permitted.

An image processing apparatus according to the present invention comprises adding means for adding an image processing command to image data, and reads image data of an original and converts thus read image data into a file format which is determined from among plural file formats, the image processing apparatus comprising: a storage unit which stores a file format which permits addition of the image processing command to the read image data; and judging means for judging whether the file format thus determined is stored in the storage unit, wherein when the judging means judges that the file format thus determined is stored in the storage unit, addition by the adding means of the image processing command to the read image data is permitted.

The image processing apparatus according to the present invention is characterized by comprising sending means for sending the image data converted into the file format thus determined.

The image processing apparatus according to the present invention is characterized in that the sending means sends an electronic mail to which the image data converted into the file format thus determined is attached.

The image processing apparatus according to the present invention is characterized in that the file format which permits addition of the image processing command to the read image data is a file format in which a destination of the image data can execute the image processing command.

The image processing apparatus according to the present invention is characterized in that the file format which permits addition of the image processing command to the read image data is PDF (Portable Document Format).

The image processing apparatus according to the present invention is characterized by comprising determining means for determining in accordance with a load condition whether to add the image processing command to the read image data, wherein when the determining means determines to add the image processing command, the judging means judges whether the file format thus determined is stored in the storage unit.

An image processing apparatus according to the present invention comprises adding means for adding an image processing command to image data, and reads image data of an original and converts thus read image data into a file format which is determined from among plural file formats, the image processing apparatus comprising: a storage unit which stores a file format which prohibits addition of the image processing command to the read image data; and judging means for judging whether the file format thus determined is stored in the storage unit, wherein when the judging means judges that the file format thus determined is stored in the storage unit, addition by the adding means of the image processing command to the read image data is prohibited.

The image processing apparatus according to the present invention is characterized in that the file format which prohibits addition of the image processing command to the read image data is TIFF (Tagged Image File Format).

An image processing method of the present invention according to which an image processing apparatus, which comprises adding means for adding an image processing command to image data and a controller which performs image processing control including control of the adding means, reads image data of an original and converts thus read image data into a file format which is determined from among plural file formats, wherein the image processing apparatus comprises a storage unit which stores a file format which permits addition of the image processing command to the image data, the controller judges whether the file format thus determined is stored in the storage unit, and when judging that the file format thus determined is stored in the storage unit, the controller permits the adding means addition of the image processing command to the read image data.

An image processing method of the present invention according to which an image processing apparatus, which comprises adding means for adding an image processing command to image data and a controller which performs image processing control including control of the adding means, reads image data of an original and converts thus read image data into a file format which is determined from among plural file formats, wherein the image processing apparatus comprises a storage unit which stores a file format which prohibits addition of the image processing command to the image data, the controller judges whether the file format thus determined is stored in the storage unit, and when judging that the file format thus determined is stored in the storage unit, the controller prohibits the adding means from adding the image processing command to the read image data.

According to the present invention, stored in the storage unit are file formats which permit addition of the image processing command to image data. A file format which read image data will be converted into is determined, the judging means judges whether thus determined file format is stored in the storage unit, and in the event that the storage has been made, addition of the image processing command to the read image data is permitted. The sending means sends the image data converted into thus determined file format, as the attachment of an electronic mail or by file transfer for example. A file format which permits addition of the image processing command to image data is a file format in which a destination of the image data can perform image processing which corresponds to the image processing command added to the image data, and may be PDF (Portable Document Format) for instance. In the event that a destination of read image data is capable of handling PDF and therefore executing image processing which corresponds to the image processing command added to PDF for example, PDF is stored in the storage unit as a file format which permits addition of the image processing command. As addition of the image processing command is permitted in accordance with whether a destination is compatible with a file format, it is possible to prevent addition of the image processing command which the destination is not compatible with and it is possible to effectively disperse a processing load between the image processing apparatus and the destination.

According to the present invention, stored in the storage unit are file formats which prohibit addition of the image processing command to image data. A file format which read image data will be converted into is determined, the judging means judges whether thus determined file format is stored in the storage unit, and in the event that the storage has been made, addition of the image processing command to the read image data is prohibited. The sending means sends the image data converted into thus determined file format, as the attachment of an electronic mail or by file transfer for example. A file format which prohibits addition of the image processing command to image data is a file format in which a destination of the image data can not perform image processing which corresponds to the image processing command added to the image data, and may be TIFF (Tagged Image File Format) for instance. As addition of the image processing command is prohibited in accordance with whether a destination is compatible with a file format, it is possible to prevent addition of the image processing command which the destination is not compatible with and it is possible to effectively disperse a processing load between the image processing apparatus and the destination.

According to the present invention, the determining means determines, in accordance with a load condition through image processing, whether to use the image processing command. Whether to use the image processing command is determined based on the free capacity in an image memory which stores image data, the processing time required for image processing or the number of pending jobs for instance. When the determining means determines to use the image processing command, the judging means judges whether the determined file format is stored in the storage unit. For example, image processing is performed usually in the image processing apparatus, but as the free capacity in the image memory becomes equal to or lower than a predetermined value or a load in the image processing apparatus otherwise becomes heavy, the image processing apparatus sends the image data to which the image processing command is added as for a file format which permits or prohibits addition of the image processing command is added and the destination executes image processing which corresponds to the image processing command. It is possible to effectively disperse a processing load between the image processing apparatus and the destination, in accordance with a load condition in the image processing apparatus.

### BRIEF DESCRIPTION OF THE DRAWINGS

FIG. 1 is a block diagram which shows an example of an image processing system which comprises an image processing apparatus (MFP) according to the present invention;

FIG. 2 is a block diagram which partially enlarges the image processing apparatus (MFP) shown in FIG. 1;

FIG. 3 is a drawing which shows an example of a setting screen for setting, for each destination, a file format which permits addition of a rotation command;

FIGS. 4A and 4B are flow charts which show an example of an image processing procedure;

FIGS. 5A and 5B are drawings which show an example of a scanning direction for scanning an original; and

FIG. 6 is a drawing which shows an example of a setting screen for setting, for each destination, a file format which prohibits addition of the rotation command.

### BEST MODE FOR IMPLEMENTING THE INVENTION

The present invention will now be described specifically while referring to the drawings which illustrate an embodiment.

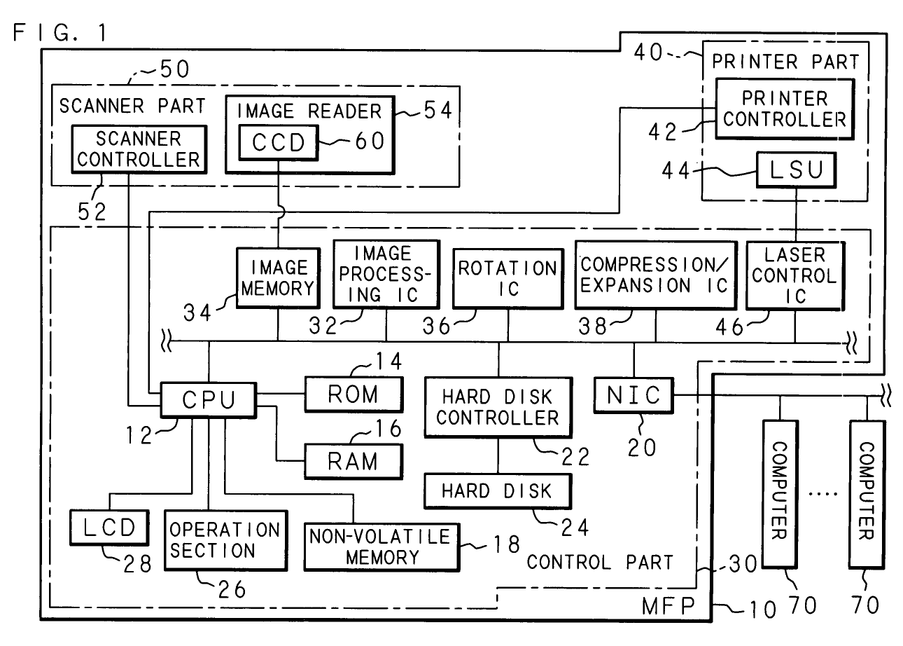

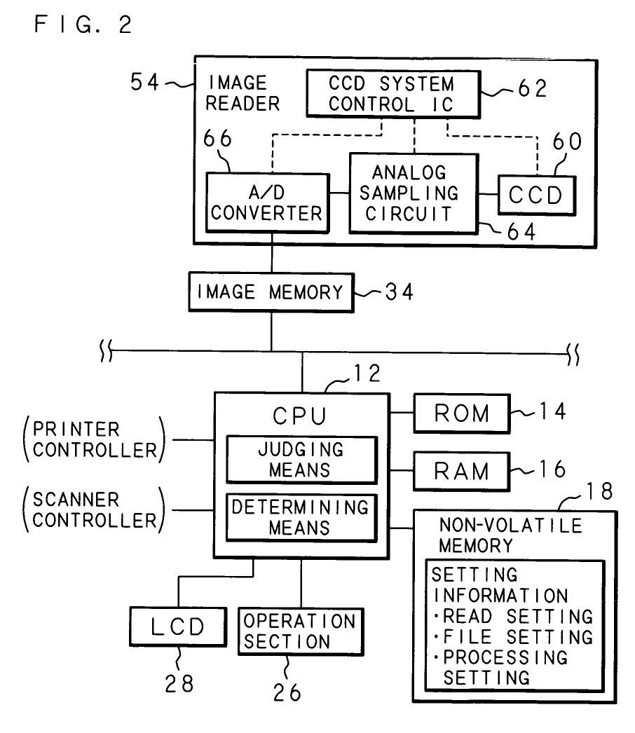

FIG. 1 is a block diagram which shows an example of an image processing system which comprises an image processing apparatus (MFP: Multi Function Peripheral) 10 according to the present invention. FIG. 2 is a block diagram which partially enlarges the image processing apparatus (MFP) 10. The MFP 10 comprises a scanner part 50 which reads image data of an original, a printer part 40 which prints the image data and a control part 30 which controls the scanner part 50 and the printer part 40 and executes image processing.

The scanner part 50 comprises an image reader 54 comprising a CCD (Charge Coupled Device) 60 and the like, a scanner controller 52 which controls reading including scanning of the original, etc. Describing the details of the image reader 54, the CCD 60 is connected with an image memory 34 via an analog sampling circuit 64 and an A/D convertor 66 as shown in FIG. 2. Further, a CCD system control IC 62 controls the CCD 60, the analog sampling circuit 64 and the AD convertor 66. As shown in FIG. 1, the printer part 40 comprises an LSU (Laser Scanning Unit) 44, a printer controller 42 which controls printing including feeding of a recording paper, etc.

The control part 30 comprises a laser control IC 46 which controls the LSU 44, the image memory 34 which stores image data received from the image reader 54, an image processing IC 32 which performs gamma correction, color number conversion, resolution conversion and the like of the image data, a rotation IC 36 which rotates the image data, a compression/expansion IC 38 which compresses and expands the data, an NIC (Network Interface Card) 20, a hard disk controller 22 and a CPU 12, each of which is connected with a common bus.

A hard disk 24 is connected with the hard disk controller 22, while a ROM 14, a RAM 16, a non-volatile memory 18, an operation section 26, an LCD (Liquid Crystal Display) 28, the scanner controller 52 and the printer controller 42 are connected with the CPU 12, and an external apparatus such as a computer 70 is connected with the NIC 20.

Under the control of the CPU 12, it is possible within the MFP 10 that the image memory 34 stores image data which the image reader 54 has read and the printer part 40 outputs the image data, or that the NIC 20 stores within the image memory 34 image data the computer 70 or an external facsimile machine, accepted from, and after gamma correction, color number conversion, resolution conversion or the like of the image by the image processing IC 32 on the image memory 34 in accordance with settings, the printer part 40 outputs the image data, or that image data which the image reader 54 has read are stored in the image memory 34, and after gamma correction, color number conversion, resolution conversion or the like of the image by the image processing IC 32 on the image memory 34 in accordance with settings, the NIC 20 sends the image data to the computer 70 or an external facsimile machine.

During transmission of image data which the image reader 54 has read from the NIC (sending means) 20 to the computer (image receiving apparatus) 70, the CPU 12 converts the read image data into a file format which is decided from among plural file formats and then sends the image data. The file format may be received from the operation section 26 or determined based on settings stored in the non-volatile memory 18. The transmission of thus converted image data may be transmission from the NIC 20 to the computer 70, which is a destination, of an electronic mail created by the CPU 12 and bearing the image data for instance. At the destination, receipt may occur via the operation section 26.

The non-volatile memory 18 operates as a storage unit which stores a file format which permits addition of a command (image processing command) to image data. A file format which permits addition of the image processing command to image data is a file format in which the computer 70 receiving the image data can execute image processing which corresponds to the command added to the image data. A file format which permits addition of the image processing command to image data may be a PDF (Portable Document Format) for instance.

Stored in the non-volatile memory 18 is setting information including read settings related to reading of an image, file settings related to a file to be sent, processing settings related to image processing, etc. The read settings include settings as for the resolution of the image (in dpi, dots per inch, for example), the direction of the image (vertical or horizontal), the color number of the image (e.g., colors, gray scale, monochrome), etc. The file settings include settings as for the file format (which may be PDF or TIFF for example), whether to compress, etc. The processing settings include settings as for prioritization (e.g., time priority, execution priority), permission or prohibition of a command (image processing command) for each file format, etc.

It is herein assumed that as the processing settings included in the setting information, whether to permit addition of a command is set for each destination and each file format. Further, the command described in the example below is a rotation command which demands rotating image data. It is the CPU (adding means) 12 that adds the command to image data. The destination and the file format may be selected, via the operation section 26, from a destination list and a file format list which are stored in the non-volatile memory 18.

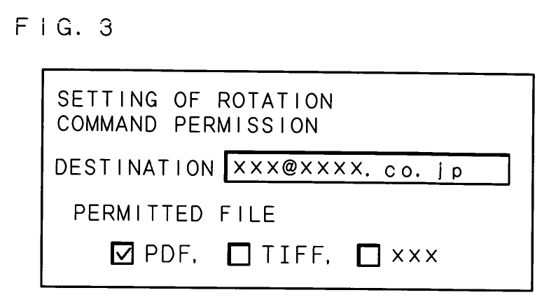

The setting information may be registered, modified or deleted via the operation section 26. The CPU 12 updates the various settings (setting information) stored in the non-volatile memory 18, in accordance with settings accepted via the operation section 26. FIG. 3 is a drawing which shows an example of a setting screen for setting, for each destination, a file format which permits addition of the rotation command. In the example in FIG. 3, addition of the rotation command to PDF is permitted according to the settings. The settings concerning the file formats which permit addition of the rotation command are registered as the processing settings included in the setting information by the control of CPU 12.

The CPU 12 operates as means (determining means) for determining whether to use the command in accordance with a load condition which may be the free capacity in the image memory 34 which stores the image data, the processing time for rotating the image data, the number of pending jobs, etc. In a high load condition that the free capacity in the image memory 34 is limited for example, addition of the command followed by rotation at the destination (i.e., in the computer 70) is likely to improve the processing efficiency.

The CPU 12 determines a post-conversion file format based on the file settings included in the setting information or the settings received via the operation section 26, and when determining to use the command in light of the load condition, operates as means (judging means) for judging whether thus determined file format is stored in the storage unit (i.e., registered in the processing settings included in the setting information), and further, when addition of the command to thus determined file format is permitted, adds the image processing command to the image data.

Reading and executing a program stored in the ROM 14, the CPU 12 operates as each means described above or controls the MFP 10 in various ways. Meanwhile, when the command is added to the image data received from the MFP 10, the computer 70 performs image processing corresponding to the added command upon the received image data.

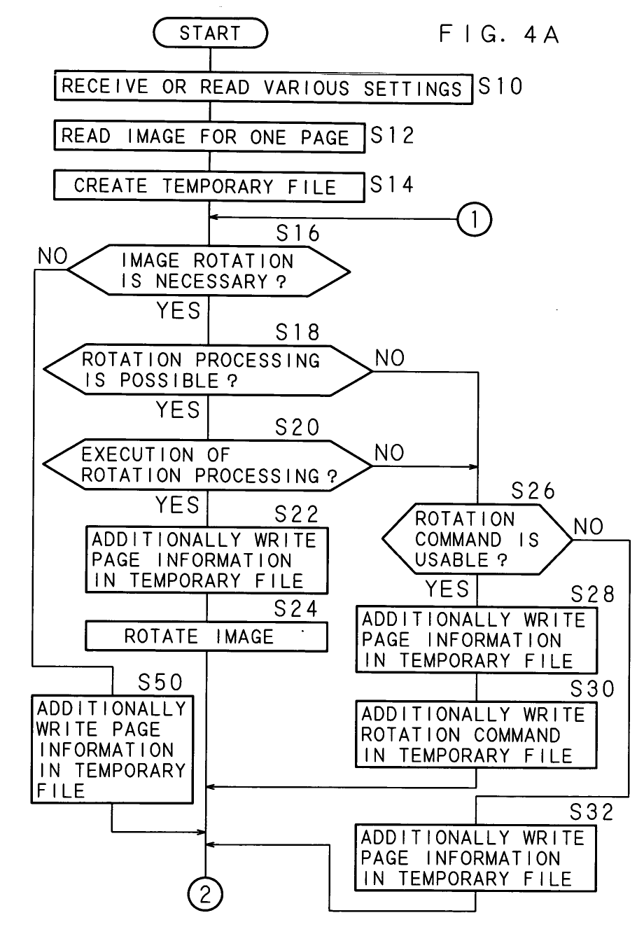

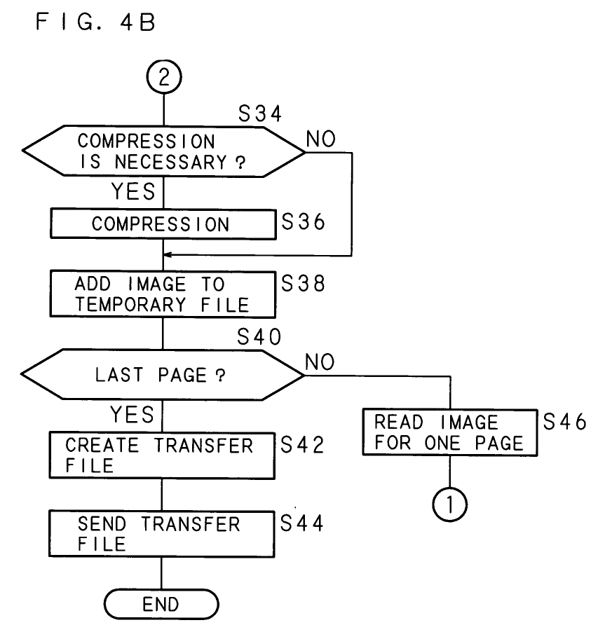

An image processing method using the image processing apparatus according to the present invention will now be described. FIGS. 4A and 4B are flow charts which show an example of an image processing procedure.

Receiving from the operation section 26 or reading from the non-volatile memory 18 various settings (e.g., the setting information, the destination, the file format) with respect to reading and transmission of image data (S10), the CPU 12 stores the various settings in the RAM 16. The CPU 12 controls the scanner controller 52 and makes the image reader 54 read image data representing one page of the original (S12), and stores thus read image data in the image memory 34 and makes the image processing IC 32 execute gamma correction, color number conversion, resolution conversion or the like of the image data on the image memory 34 in accordance with the read settings. In the event that thus read image data represent the first page, the CPU 12 creates (stores) a temporary file in the hard disk 24 based on the file format determined in accordance with the various settings stored in the RAM 16 (S14).

The CPU 12 judges whether it is necessary to rotate the image data (S16). For example, the CPU 12 compares the direction of the image (vertical or horizontal) included in the read settings among the various settings stored in the RAM 16 with the scanning direction (the vertical direction or the horizontal direction) for scanning the original received from the scanner controller 52 and stored in the RAM 16, and when these directions are different, the CPU 12 determines that it is necessary to rotate the image data.

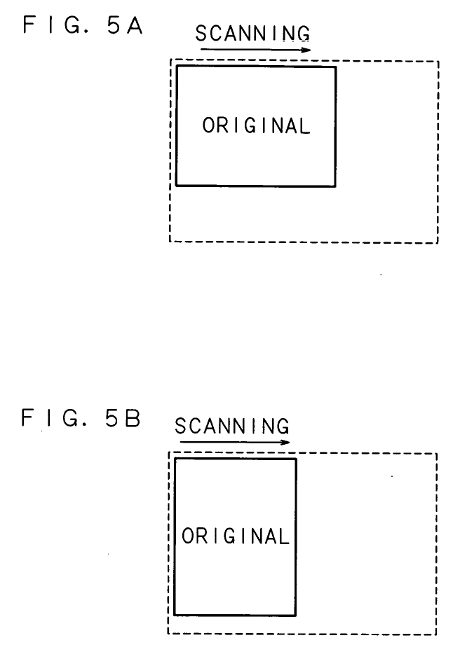

FIGS. 5A and 5B are drawings which show an example of the scanning direction for scanning the original. The scanner part 50 comprises a size sensor (not shown) which detects the length (the size along the scanning direction) and the width (the size along a direction perpendicular to the scanning direction) of the original to be read, and the CPU 12, receiving the detected length and width of the original from the scanner part 50, decides whether the scanning direction is the vertical direction as shown in FIG. 5A or the horizontal direction as shown in FIG. 5B. Where the direction must be vertical according to the setting regarding the direction of the image (read setting) among the various settings stored in the RAM 16, the CPU 12 decides that it is not necessary to rotate when finding the scanning direction to be the vertical direction as shown in FIG. 5A but decides that it is necessary to rotate when the scanning direction is the horizontal direction as shown in FIG. 5B.

When the rotation processing is necessary (S16: YES), the CPU 12 judges whether the rotation processing is possible. For instance, the CPU 12 confirms the free capacity in the image memory 34, and when finding that the free capacity is equal to or exceeds a predetermined value, decides that the rotation processing is possible. When deciding that the rotation processing is possible (S18: YES), the CPU 12 judges whether to execute the rotation processing. For example, the CPU 12 refers to priority items (e.g., priority time, priority execution) included in the processing settings of the various settings stored in the RAM 16, and when priority execution is demanded, decides to execute the rotation processing.

For execution of the rotation processing (S20: YES), the CPU 12 additionally writes page information related to the read image data in the temporary file (S22), and makes the rotation IC 36 rotate the image data stored in the image memory 34 (S24).

When the rotation processing is impossible (S18: NO) or the rotation processing needs not be executed (S20: NO), the CPU 12 judges whether the rotation command is usable. For example, the CPU 12 judges if the command is usable based on the file format and the destination determined in accordance with the various settings stored in the RAM 16 and permission or prohibition of the command included in the processing settings of the various settings stored in the RAM 16.

When the rotation command is usable (S26: YES), the CPU 12 additionally writes page information related to the read image data in the temporary file (S28) and further additionally writes the rotation command in the temporary file (S30). When the rotation command is not usable (S26: NO), the CPU 12 additionally writes page information related to the read image data in the temporary file (S32).

When the rotation processing is unnecessary (S16: NO), the CPU 12 additionally writes page information related to the read image data in the temporary file (S50). Upon execution of the rotation processing (S24), additional writing of the rotation command in the temporary file (S30) or additional writing of page information in the temporary file (S32, S50), the CPU 12 judges whether compression processing is necessary. The CPU 12 judges whether compression is necessary while referring to the file settings included in the various settings stored in the RAM 16 and seeing if compression is contained in the file settings, for instance.

When compression is necessary (S34: YES), the CPU 12 makes the compression/expansion IC 38 execute the compression processing and adds thus compressed image data (S36) or the image data as they are not compressed (S34: NO) to the temporary file (stores in the hard disk 24) (S38). In the event that the original which is being read has not come to the last page (S40: NO), the scanner part 50 reads an image representing one page (S46) and the process at and following S16 is performed in a similar procedure to the above. In the event that the original has come to the last page (S40: YES), the CPU 12 creates a transfer file which is in the file format determined as described above (S42) and stores the same in the hard disk 24, creates an electronic mail to which the transfer file is attached and stores the same in the hard disk 24, and then sends this from the NIC 20 (S44).

Although the embodiment above requires setting a file format which permits addition of the image processing command, a file format which prohibits addition of the image processing command may be set. In this case, the non-volatile memory 18 operates as a storage unit which stores a file format which prohibits addition of a command (image processing command) to image data.

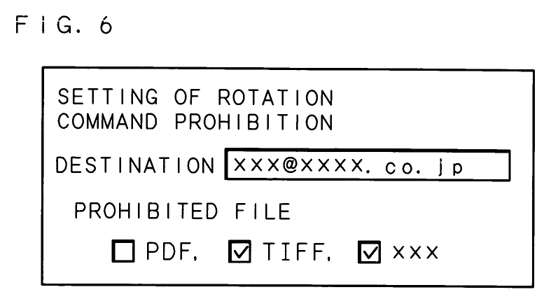

A file format which prohibits addition of the image processing command to image data may be TIFF (Tagged Image File Format) for instance. Where this is used, the processing settings included in the setting information set, for each destination and file format, whether to prohibit addition of the command. FIG. 6 is a drawing which shows an example of a setting screen for setting, for each destination, a file format which prohibits the rotation command. In the example in FIG. 6, according to the settings, the rotation command is prohibited in the case of TIFF and a file format (denoted at XXX in FIG. 6) which is not compatible with the command. The CPU 12 determines a post-conversion file format based on the setting information or the settings received via the operation section 26, and when addition of the command to thus determined file format is prohibited, prohibits addition of the image processing command to image data.

### INDUSTRIAL APPLICABILITY

According to the present invention, it is possible to set whether to permit addition of the image processing command in accordance with whether a destination is compatible with a file format and it is therefore possible to prevent addition of the image processing command which the destination is not compatible with. As addition of the image processing command is permitted in accordance with the compatibility with the image processing command, it is possible to effectively disperse a processing load between the image processing apparatus and the destination.

According to the present invention, it is possible to set whether to prohibit addition of the image processing command in accordance with whether a destination is compatible with a file format and it is therefore possible to prevent addition of the image processing command which the destination is not compatible with. As addition of the image processing command is prohibited in accordance with the compatibility with the image processing command, it is possible to effectively disperse a processing load between the image processing apparatus and the destination.

According to the present invention, whether to use the image processing command is determined in accordance with a load condition in the image processing apparatus, which makes it possible to effectively disperse a processing load between the image processing apparatus and the destination. For instance, image processing is performed usually in the image processing apparatus, and as a load in the image processing apparatus becomes heavy, for a destination which permits addition of the image processing command, using the image processing command, it is possible to execute image processing at the destination.

1-11. (canceled)

12. An image processing system, comprising:
an image processing apparatus which comprises an adding unit which adds an image processing command to image data, reads image data of an original and converts thus read image data into a file format which is determined from among plural file formats; and
an image receiving apparatus which receives from said image processing apparatus the image data converted into the file format thus determined, and when the image processing command is added to the image data thus received, performs upon thus received image data an image processing which corresponds to the image processing command thus added;
wherein said image processing apparatus comprises:
a storage unit which stores a file format which permits addition of the image processing command to the read image data; and
a judging unit which judges whether the file format thus determined is stored in said storage unit, and
when said judging unit judges that the file format thus determined is stored in said storage unit, addition by said adding unit of the image processing command to the read image data is permitted.

13. An image processing apparatus which comprises an adding unit which adds an image processing command to image data, reads image data of an original and converts thus read image data into a file format which is determined from among plural file formats, said image processing apparatus comprising:
a storage unit which stores a file format which permits addition of the image processing command to the read image data; and
a judging unit which judges whether the file format thus determined is stored in said storage unit,
wherein when said judging unit judges that the file format thus determined is stored in said storage unit, addition by said adding unit of the image processing command to the read image data is permitted.

14. The image processing apparatus in accordance with claim 13, wherein the file format which permits addition of the image processing command to the read image data is PDF (Portable Document Format).

15. The image processing apparatus in accordance with claim 13, further comprising a determining unit which determines, in accordance with a load condition, whether to add the image processing command to the read image data,
wherein when said determining unit determines to add the image processing command, said judging unit judges whether the file format thus determined is stored in said storage unit.

16. The image processing apparatus in accordance with claim 13, further comprising a sending unit which sends the image data converted into the file format thus determined.

17. The image processing apparatus in accordance with claim 16, wherein the file format which permits addition of the image processing command to the read image data is a file format in which a destination of the image data can execute the image processing command.

18. The image processing apparatus in accordance with claim 16, wherein the file format which permits addition of the image processing command to the read image data is PDF (Portable Document Format).

19. The image processing apparatus in accordance with claim 16, further comprising a determining unit which determines, in accordance with a load condition, whether to add the image processing command to the read image data,
wherein when said determining unit determines to add the image processing command, said judging unit judges whether the file format thus determined is stored in said storage unit.

20. The image processing apparatus in accordance with claim 16, wherein said sending unit sends an electronic mail to which the image data converted into the file format thus determined is attached.

21. The image processing apparatus in accordance with claim 20, wherein the file format which permits addition of the image processing command to the read image data is a file format in which a destination of the image data can execute the image processing command.

22. The image processing apparatus in accordance with claim 20, wherein the file format which permits addition of the image processing command to the read image data is PDF (Portable Document Format).

23. The image processing apparatus in accordance with claim 20, further comprising a determining unit which determines, in accordance with a load condition, whether to add the image processing command to the read image data,
wherein when said determining unit determines to add the image processing command, said judging unit judges whether the file format thus determined is stored in said storage unit.

24. An image processing apparatus which comprises an adding unit which adds an image processing command to image data, reads image data of an original and converts thus read image data into a file format which is determined from among plural file formats, said image processing apparatus comprising:
a storage unit which stores a file format which prohibits addition of the image processing command to the read image data; and
a judging unit which judges whether the file format thus determined is stored in said storage unit,
wherein when said judging unit judges that the file format thus determined is stored in said storage unit, addition by said adding unit of the image processing command to the read image data is prohibited.

25. The image processing apparatus in accordance with claim 24, wherein the file format which prohibits addition of the image processing command to the read image data is TIFF (Tagged Image File Format).

26. An image processing method according to which an image processing apparatus, which comprises an adding unit which adds an image processing command to image data and a controller which performs image processing control including control of said adding unit, reads image data of an original and converts thus read image data into a file format which is determined from among plural file formats, said image processing method comprising steps of:
disposing to said image processing apparatus a storage unit which stores a file format which permits addition of the image processing command to the image data;
making said controller judge whether the file format thus determined is stored in said storage unit; and
making said controller permit addition by said adding unit of the image processing command to the read image data, when it is judged that the file format thus determined is stored in said storage unit.

27. An image processing method according to which an image processing apparatus, which comprises an adding unit which adds an image processing command to image data and a controller which performs image processing control including control of said adding unit, reads image data of an original and converts thus read image data into a file format which is determined from among plural file formats, said image processing method comprising steps of:
disposing to said image processing apparatus a storage unit which stores a file format which prohibits addition of the image processing command to the image data;
making said controller judge whether the file format thus determined is stored in said storage unit; and
making said controller prohibit addition by said adding unit of the image processing command to the read image data, when it is judged that the file format thus determined is stored in said storage unit.
